(19) United States
(12) Patent Application Publication
(10) Pub. No.: US 2019/0026991 A1
(43) Pub. Date: Jan. 24, 2019

(54) PEER-TO-PEER SKILL-BASED GAMING SYSTEM AND METHOD FOR UTILIZING THE SAME

(71) Applicants: Jared Torres, Henderson, NV (US); John Finkbeiner, Henderson, NV (US)

(72) Inventors: Jared Torres, Henderson, NV (US); John Finkbeiner, Henderson, NV (US)

(21) Appl. No.: 15/623,260

(22) Filed: Jun. 14, 2017

(51) Int. Cl. G07F 17/32; G06Q 50/34; G06F 21/32

(52) U.S. Cl. CPC G07F 17/3276; G06Q 50/34; G06F 21/32; G06F 2221/2111; G07F 17/3241; G07F 17/3295; G07F 17/3225

(57) ABSTRACT

A peer-to-peer skill-based game system having one or more game host servers accessible via remote game devices; a skill-based application and wagering software on the remote game devices; one or more databases and a remote wagering management server configured to: (i) validate and authenticate players and locations thereof; (ii) manage wagers between players; (iii) match players based on pre-established parameters and (iv) communicate with remote game devices. The system allows players to locate other players to wager against in skill-based video game challenges. The challenges may be played via mobile devices or other computer-based systems. Real-time biometric data may be collected systematically or randomly to ensure the continued authentication of the players during play. The system may be configured to calculate real-time, in-game odds to facilitate the posting of propositional wagers to persons watching the game. Geo-location technology permits players in defined geo-fenced areas to challenge one another.

### FIELD OF THE INVENTION

The embodiments of the present invention relate to a peer-to-peer, skill-based gaming system.

### BACKGROUND

Skill-based gaming has long been a target of casinos and other wagering outlets. Recently, certain jurisdictions, including Nevada have legalized wagering on the outcomes of skill-based games. The wagers may be based on a player v. machine model, player v. player model or a model whereby players bet on game outcomes. In either instance, the player or players are involved in a skill-based event (rather than a randomly-determined event which is the prevalent model in casinos today).

Given the fact that skill-based gaming played pursuant to a casino-style model is in its early stages, there is a push to determine how to best implement skill-based gaming into a casino-style model.

Accordingly, it would be advantageous to develop a skill-based gaming system allowing wagers on skill-based games. Advantageously, the skill-based gaming system should have security protocols for authenticating players. The skill-based system may also comprise a skill-based video system.

### SUMMARY

A first embodiment of the present invention relates to a peer-to-peer skill-based gaming system comprising one or more game host servers accessible via remote game devices; skill-based application and wagering software on said game devices; one or more databases and a remote wagering management server configured to: (i) validate and authenticate players and locations thereof; (ii) manage wagers between players; (iii) match players based on pre-established parameters including at least one of skill level and wager amount; and (iv) facilitate communications with said remote game devices.

With the peer-to-peer skill-based game system described herein, players may locate other players to wager against in skill-based video (or non-video) game challenges. The challenges may be played via mobile device or other computer-based systems such as desktops. In one embodiment, competing players must be located in a geo-fenced area defined by geo-location technology. Player locations may be required to ensure players are in a jurisdiction permitting skilled-based gaming.

In one embodiment, real-time biometric data are collected systematically or randomly to ensure the continued authentication of the players. For example, biometric data in the form of a fingerprint may be collected systematically via a mobile device.

In another embodiment, the system is configured to calculate real-time, in-game odds to facilitate the posting of propositional wagers for persons watching the game.

Other variations, embodiments and features of the present invention will become evident from the following detailed description, drawings and claims.

### BRIEF DESCRIPTION OF THE DRAWINGS

FIG. 1 illustrates a system architecture for a peer-to-peer system according to the embodiments of the present invention;

FIG. 2 illustrates a flow chart detailing one methodology associated with the peer-to-peer system according to the embodiments of the present invention;

FIG. 3 illustrates a system architecture for a real-time proposition wagering application according to the embodiments of the present invention;

FIG. 4 illustrates a flow chart detailing one methodology associated with the real-time proposition application according to the embodiments of the present invention;

FIG. 5 illustrates a geo-fencing system according to the embodiments of the present invention;

FIG. 6 illustrates a flow chart detailing one methodology of utilizing a geo-fenced area according to the embodiments of the present invention;

FIG. 7 illustrates a block diagram of a biometric component according to the embodiments of the present invention; and

FIGS. 8A-8H illustrate a series of exemplary mobile device screen shots according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

As will be appreciated by one skilled in the art, the embodiments of the present invention combine software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for embodiments of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Mobile devices as used herein include desktop computers, laptop computers, tablets, smart phones and the like. The embodiments of the present invention may be implemented as a dedicated website and/or mobile application. The use of wager and wagering herein are synonymous with bet and betting.

The embodiments of the present invention relate to a peer-to-peer, challenge/bet system allowing users/players to search and find other users/players of skill-based video games and bet (or challenge) that player for money or other consideration. The system facilitates the wager between the two players, records and validates results, manages an escrow for the two players and automatically transfers results to the winning player. While video games are highlighted herein, non-video games may also facilitate embodiments of the present invention.

The embodiments of the present invention may be used with any number of video games including traditional video game shooting titles (e.g., Halo®), sports titles (e.g., Madden Football®), puzzle titles (e.g., Minecraft®), etc. Some embodiments may also be used with live sporting events and the like.

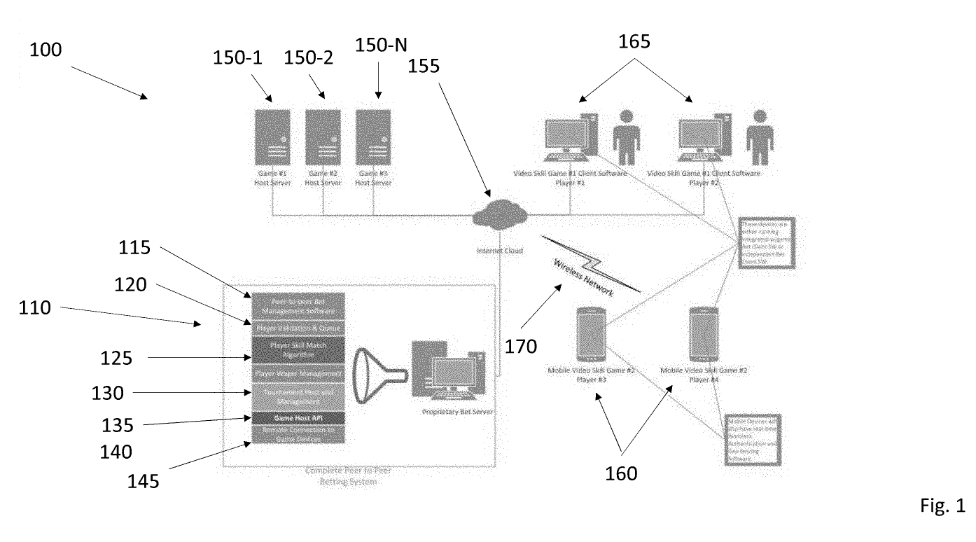

FIG. 1 shows a system architecture 100 for a peer-to-peer system according to the embodiments of the present invention. In one embodiment, a central computer (e.g., peer-to-peer server) 110 may comprise peer-to-peer wager management software 115, player validation and queue software 120, a player skill match algorithm 125, player wager management software 130, tournament host and management software 135, game host API 140 and a remote connection to remote mobile game devices 145. One or more game host servers 150-1 through 150-N communicate wirelessly with the peer-to-peer server 110. In one embodiment, the game host servers 150-1 through 150-N may each host a different game. Alternatively, multiple games may be hosted on one or more host game servers. The communication between the one or more game servers 150-1 through 150-N and peer-to-peer server 110 may be accomplished using an Internet connection 155.

Players may access the game servers 150-1 through 150-N via mobile devices 160, such as hand-held phones, tablets and laptop computers, and desktop computers 165. The mobile devices 160 access the game host servers 150-1 through 150-N via a wireless network 170 while the desktop computers 165 may access the game host servers 150-1 through 150-N via wireless or wired connections. Client-side wagering software is loaded on said mobile devices 160 and desktop computers 165

The peer-to-peer system 100 allows players to locate other players available to participate in a skill-based video game on which to wager other players. The players may determine the wager amount or the system 100 may provide options and/or ranges. The system 100, via the wager management software 115, facilitates the wager between the two players, records and validates a wager outcome and manages an escrow account to transfer winnings to the winning player.

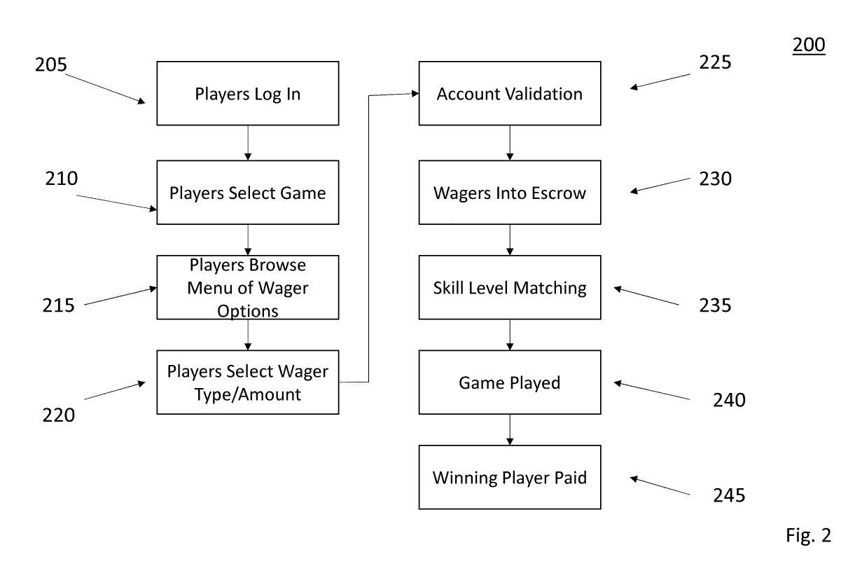

Now referring to FIG. 2, a flow chart 200 details one methodology associated with the peer-to-peer system 100 according to the embodiments of the present invention. At 205, users/players login to the system 100 via client-side wagering software remotely through an integrated client-side skill-game application or directly through a client-side wagering application on the game devices. In one embodiment, client-side wagering software serves to ensure the integrity of software and monitor against tampering of the software while the game is being played. At 210, players select a game from a plurality of games. At 215, players browse a menu of wager options available for the selected game and skill level associated with the player. As set forth above, the system 100 may control wager limits. At 220, players select the wager type/amount. At 225, the system 100 performs an account validation confirming the players' identification and availability of funds in each of the player's accounts. Optionally, geo-location may be used or required by certain jurisdictions for regulatory purposes. For example, a state may require that geo-location be used to confirm that competing players are within the borders of the state. At 230, wagers are placed into an escrow account pending game play. At 235, the system 100 undertakes a skill-level matching exercise to match the player and wager amount to another player in queue. At 240, the game is played between the two players either heads up or individually against the computer depending on the selected game and/or desire of the players. At 245, a game outcome is validated and the system 100 transfers winnings from the escrow account to the winning player. In one embodiment, prior to paying the winning player, the house/operator collects a small portion/percentage of the escrow account as a fee for operating the game.

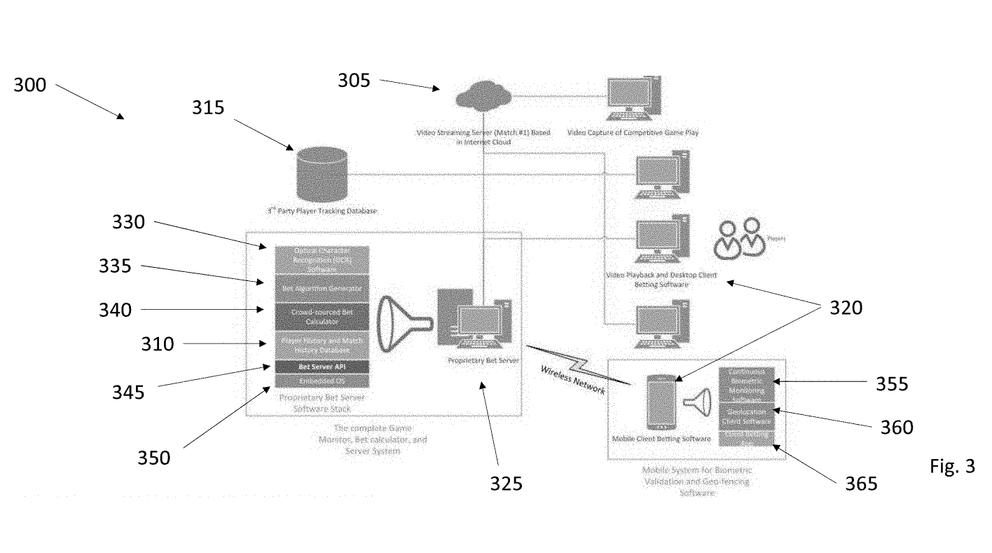

FIG. 3 illustrates a system architecture 300 for a real-time proposition wagering application according to the embodiments of the present invention. The real-time proposition wagering application utilizes real-time game data to calculate odds and post pre-game and in-game proposition wagers for users/players watching the game. In one embodiment, real-time data is collected from traditional APIs and optical character recognition data derived from game-related webpages. For example, an in-game propositional wager may be based on a kill-to-death ratio for the game players. More specifically, an in-game propositional wager may be premised on predicting the over/under threshold of the kill-to-death ratio of one player. In one embodiment, the odds change in real-time. Lines may be established before competitions allowing players or spectators to place pre-game wagers.

In one embodiment, the real-time proposition wagering application utilizes hardware/software comprising: (i) video capture software; (ii) video streaming software and server 305; (iii) centralized 310 and distributed databases 315; (iv) client-side wagering software 320 (loaded on game devices); (v) wagering management software and (vi) wager algorithm server 325. The wager algorithm server 325 may be algorithm based or wager-selection determined. In one embodiment, the wager algorithm server 325 runs the following software: (i) optical character recognition software 330 or a video frame grabber; (ii) wager algorithm 335; (iii) crowd-sourced wager calculator 340; (iv) player account management software 345; (v) wager server API 350 facilitating communication between a remote wager server and client-side wagering software and (vi) an embedded operating system 355. The client-side wagering software 320 includes biometric monitoring software 355, geo-location client software 360 and client wagering app 365.

Depending on the embodiment, the system 300 may process wagers utilizing (i) a single API between the remote wager server and a game host server or (ii) screen capture and analysis independent of the game server while using streamed video to capture and analyze video frames.

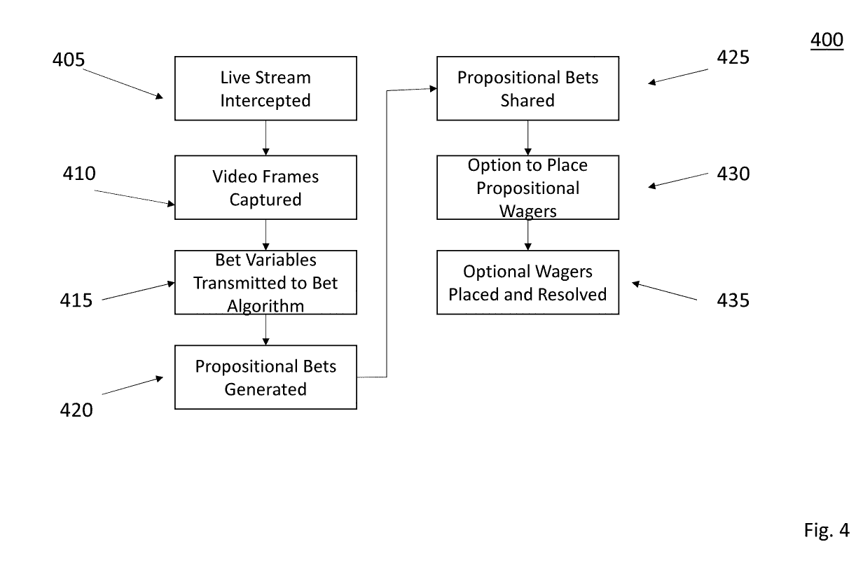

Now referring to FIG. 4, a flow chart 400 details one methodology associated with the real-time proposition application according to the embodiments of the present invention. At 405, the remote wager server intercepts and captures live stream of game (or sporting event). Alternatively, the system is integrated directly with the game host server or game-client code to obtain actual game code generated information usable to ascertain wager variables for determining formulaically odds and wager lines. At 410, the video frame capture software captures and decodes video frames for purposes of identifying wager variables to create in-game situational wagers. Wager variables may include items such as player position, remaining health, win condition progress and interim win condition progress. Those skilled in the art will recognize that there are countless wager variables that may be identified and utilized. At 415, wager variables are transmitted to the wager algorithm 335 which is configured to use historical information, in-game trends and predictive algorithms to generate propositional wagers. In one embodiment, a database is used to capture game data to generate trend-based wager propositions (e.g., based on the number of times a player has died, calculate the probability of dying again in the same game). At 420, the propositional wagers are generated. At 425, the generated propositional wagers are shared with the game client software through a browser or native applications on the game devices 320. At 430, players have the option to place a wager on the generated propositions. At 435, if wagers are placed on the propositions, the wagers are transmitted to the remote wager server for validation and accounting.

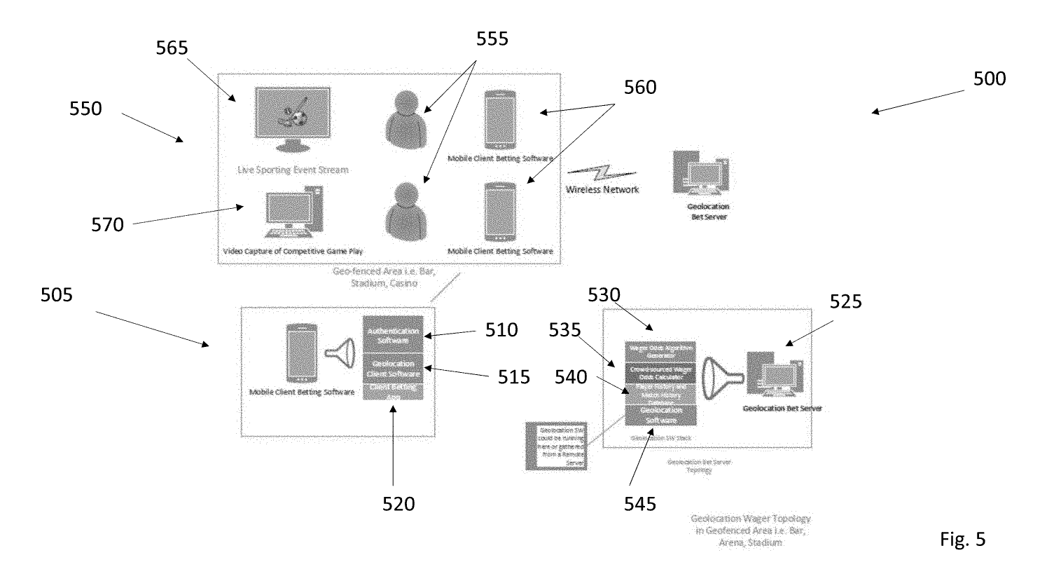

FIG. 5 illustrates a geo-fencing system 500 according to the embodiments of the present invention. The geo-fencing system 500 is configured to allow users/players the ability to place real-time wagers against other users/players in a same location as defined by a geo-fenced location algorithm running on a system server. With this embodiment, users may wager on live events broadcast on television, radio, web-based media, mobile devices or any other media configured to broadcast live events.

In one embodiment, the geo-fencing system 500 comprises server-side software in form of a mobile application 505 including a user authentication module 510, geo-location software 515 and wagering application 520, and a geo-location wager server 525 including a wager odds algorithm generator 530, crowd-sourced wager odds calculator 535, player history and match history database 540 and geo-location software 545. As shown, a geo-fenced area 550 (e.g., bar, casino, stadium, building, aircraft, ship, etc.) contains users/players 555, mobile devices 560, live event broadcast/stream 565 and video capture 570.

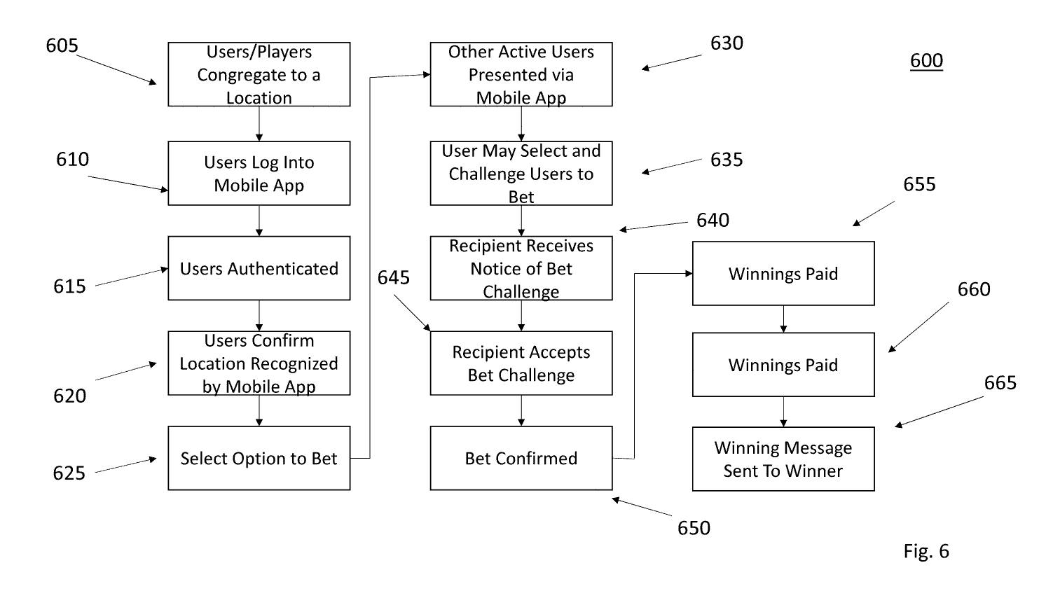

FIG. 6 illustrates a flow chart 600 detailing one methodology of utilizing the geo-fenced area 550 according to the embodiments of the present invention. At 605, users congregate at a location (e.g., sports bar or arena) broadcasting, streaming or telecasting of live events. At 610, users access and login to the mobile wagering application previously downloaded on their mobile devices. User accounts, holding cash, virtual currency or virtual goods, are managed on the wager server 525. At 615, users are authenticated. If the user is not authenticated, the user authenticates using a password methodology. At 620, once authenticated, users confirm their location is recognized by the mobile wagering application. If a user's location is not confirmed, the user may need to confirm that the “location services” feature on their game device is enabled. Once a user confirms his or her location, at 625, the user may select the option to wager other users within the geo-fenced location. The geo-fenced location may be defined as a physical location, such as a bar, stadium, venue or geographical location, such as a city or town. In one embodiment, location properties are managed by the wagering server 525 and may be defined by an event type on which a wager may be placed. Once the user selects to wager other users at the geo-fenced location, at 630, the user is presented with a list of other active users within the geo-fenced location. At 635, the user may select and challenge another user to wager on an event.

Event wagers, including wager odds and related data, are displayed via the mobile application and available from the wager server 525. Depending on the geo-fenced location, there may be more than one event on which to wager or no events on which to wager. Event wagers may relate to portions of a game (e.g. first quarter) or through the final outcome of the game. Wagering server logic controls event wagers for live events. At 640, the recipient of the wager challenge at 635, receives notification that he or she has been challenged to a wager. The recipient receives the challenger's username as well as location. In one embodiment, the challenger may input location detail such as “front bar” or “Section H, Row 7” so that the challenger and recipient may locate one another if desired. At 645, the recipient accepts the wager challenge and the challenger and recipient select the wager (e.g., cash, virtual currency or virtual goods). At 650, once the wager type and amount has been agreed to by the challenger and recipient, the wager is confirmed and details recorded on the wager server 525. In one embodiment, while the event is taking place, the challenger and recipient may, via the mobile application, send messages, texts, images, emoticons and other items to one another. At 655, once the event having been wager upon concludes, the wager server 525 confirms the event outcome and awards the wager to the winning user/player. At 660, the winner receives a message confirming the win and transfer of winnings to the user's account while the loser receives a message confirming the loss. At 665, the loser receives a message confirming the loss and transmission of winnings to the winning player.

The geo-fencing configuration may allow people with similar interests in the defined area to connect with one another (e.g., chat rooms). This configuration also provides an ideal opportunity for targeted advertising within the defined area given the interests of the people are likely aligned. Accordingly, an advertiser may target a group of people with the same general interests in a well-defined location. In one embodiment, an advertiser may be privy to the time, location and event being watched such that localized ads may be presented to the group.

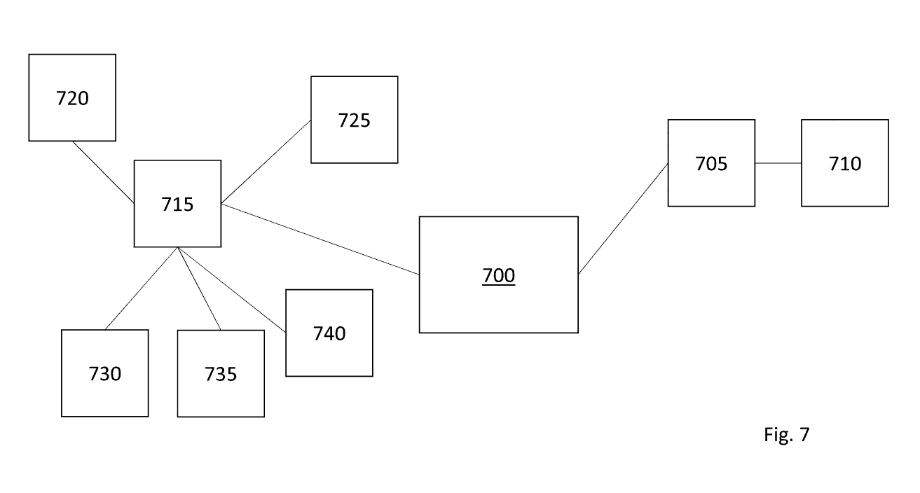

In one embodiment, the system described herein includes an active and ambient monitoring system that uses one or more biometric inputs to continuously authenticate players in a remote video game competition/match. As part of the registration, users/players provide biometric data for storage and later comparison to newly collected biometric data. In such an embodiment, as shown in FIG. 7, the client-side wagering software 700 may include multiple biometric sensing scanners and associated hardware such as facial and retina scanning application 705 which may comprise a visual and infrared spectrum camera system 710. The client-side wagering software 700 may further operate with fingerprint scanning hardware 715 such as an optical scanner 720, capacitive scanner 725, ultrasonic scanner 730, microwave scanner 735 and dedicated fingerprint scanning integrated chip 740.

With the biometric applications in place, once a game or match begins, the system causes the biometric means to begin collecting biometric data of the players involved. Players may be prompted at certain intervals (random or systematic) to utilize the biometric means associated with the game devices to input biometric data to confirm the identity of the players. The system may also cause the biometric means to continuously collect biometric data. For example, a retina scanner may be persistently reading each player's iris data to monitor identify during the play of a game. A negative ID is analyzed against error correction algorithms to determine the likelihood that the negative ID is accurate. A confirmed negative ID interrupts and voids the game/match or causes the negative ID player to forfeit the game/match.

The collection of biometric data is beneficial to ensure the integrity of opponents playing one another (i.e., no substituting a superior player for an inferior player to win a competition and prize). Moreover, the biometric data may be used to verify identity for purposes of confirming the player is of age to place bets or other administrative matters.

In one embodiment, the two players may have access to live video of the other player via the game device camera. In such an instance, the players manually authenticate each other during play (i.e., the players can visualize that competing players have not allowed another player to take over play).

The embodiments of the present invention may be used to create a skill-based video game tournament whereby players are matched up against one another in a bracket format for example.

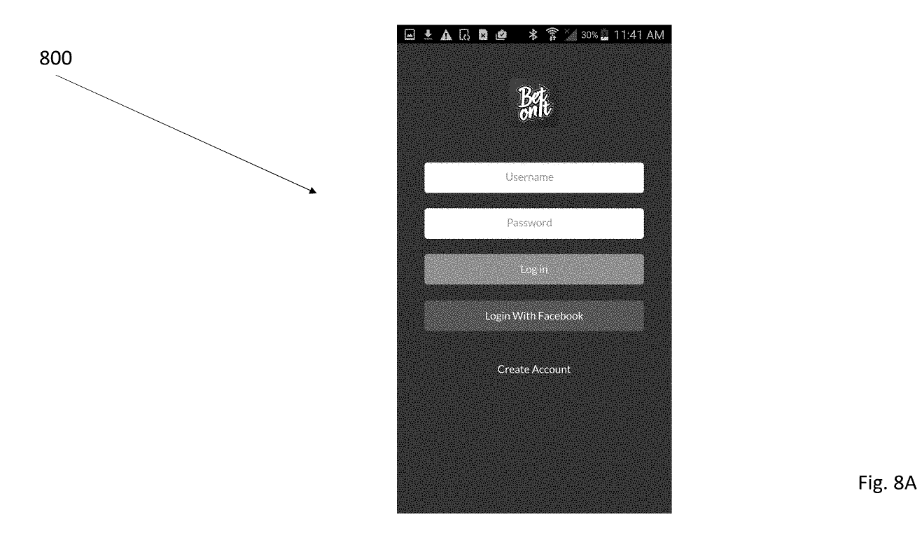

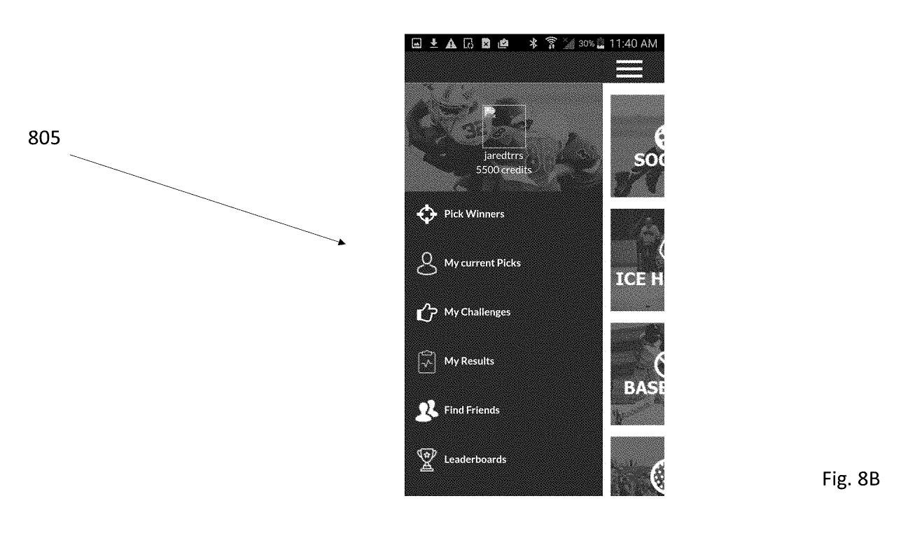

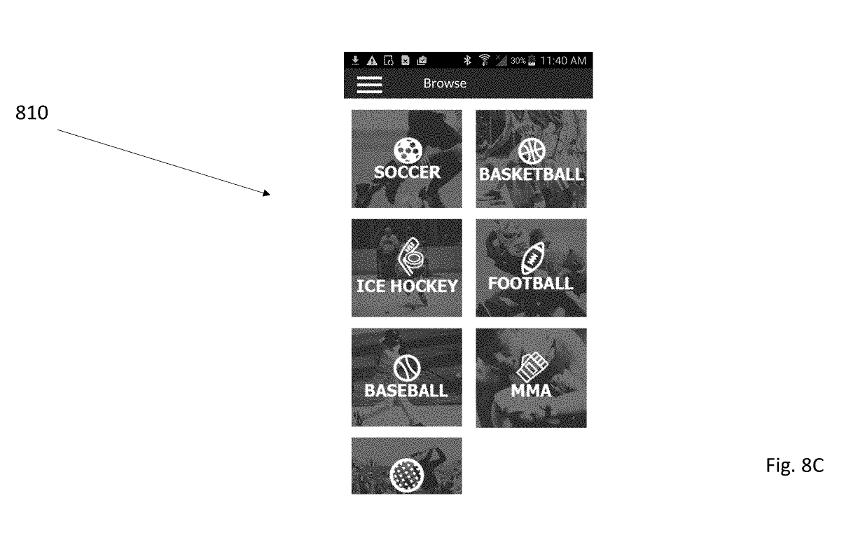

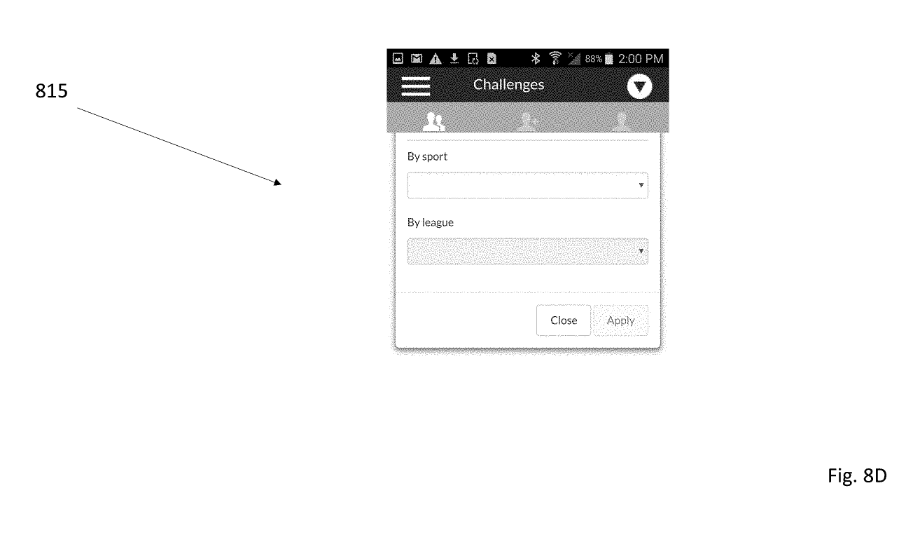

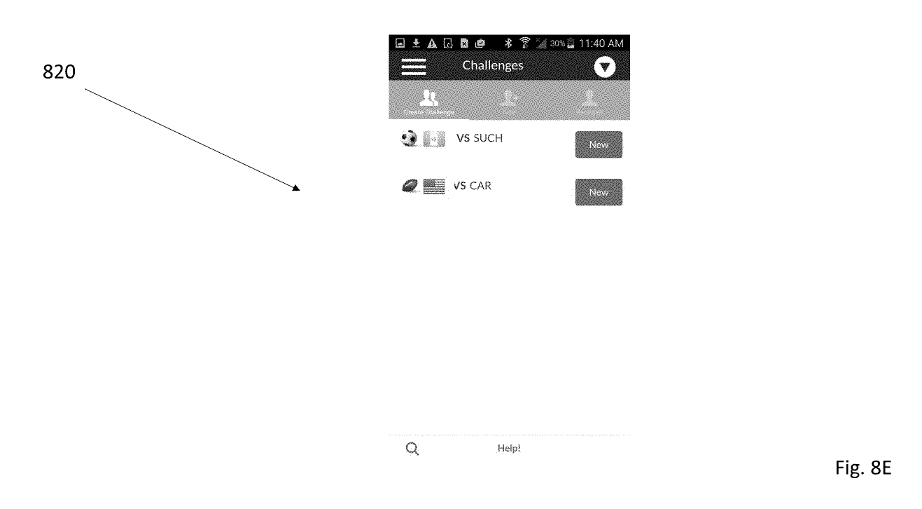

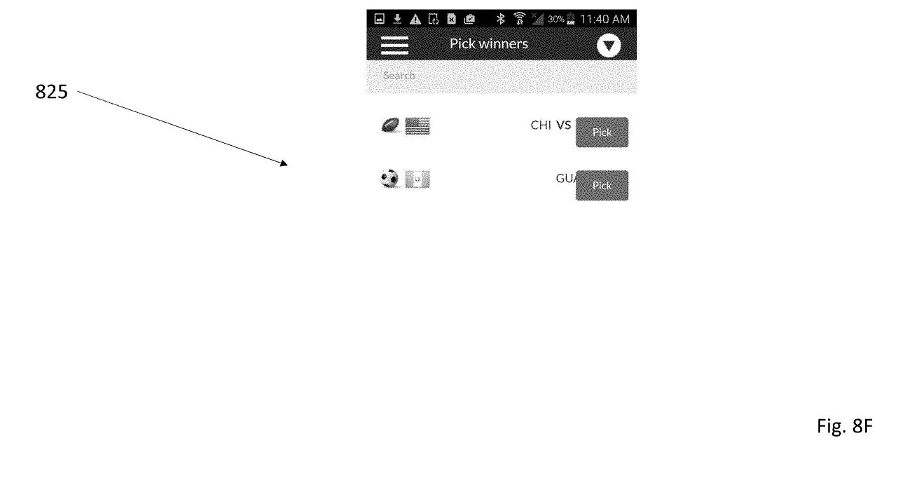

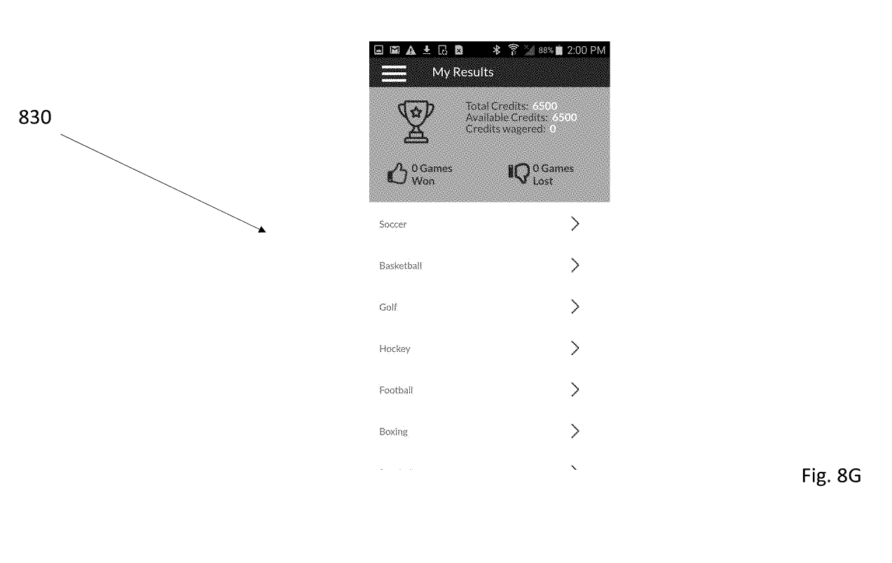

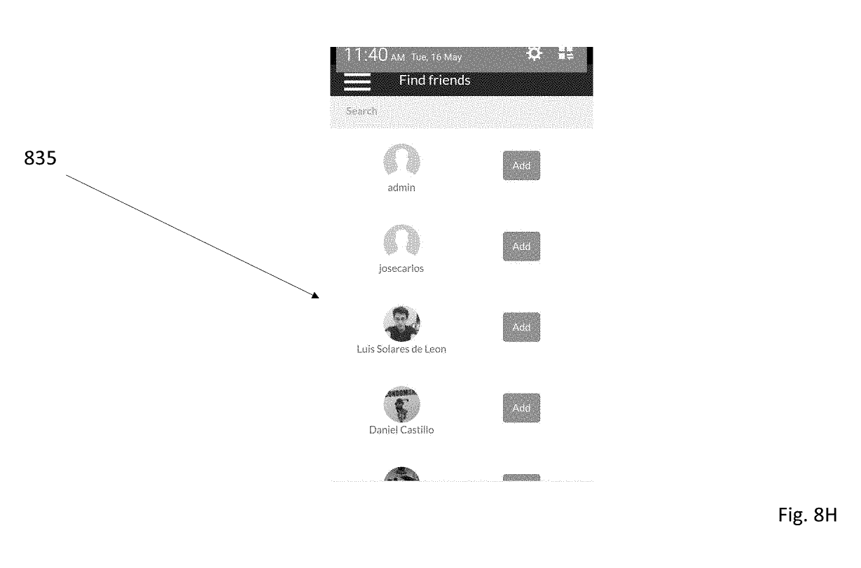

FIGS. 8A-8H show a series of exemplary mobile device screen shots according to the embodiments of the present invention. FIG. 8A shows a screenshot 800 depicting a login interface including Username, Password and Create Account boxes. FIG. 8B shows a screenshot 805 depicting a menu listing Pick Winners, My Current Winners, My Challenges, My Results, Find Friends and Leaderboards. FIG. 8C shows a screenshot 810 depicting a sports-betting menu. FIG. 8D shows a screenshot 815 depicting a challenges page searchable by sport and league. FIG. 8E shows a screenshot 820 depicting new soccer and football challenges. FIG. 8F shows a screenshot 825 depicting a Pick Winners selection page. FIG. 8G shows a screenshot 830 depicting a user's results. FIG. 8H shows a screenshot 835 depicting a Find Friends page allowing users to find and communicate with one another.

Although the invention has been described in detail with reference to several embodiments, additional variations and modifications exist within the scope and spirit of the invention as described and defined in the following claims.

We claim:

1. A computer-implemented peer-to-peer skill-based gaming system comprising:
one or more game host servers accessible via remote game devices;
a skill-based game application and wagering software on said remote game devices;
one or more databases; and
a remote wagering management server configured to: (i) validate and authenticate players and locations thereof; (ii) accept and manage wagers between players; (iii) match players based on pre-established parameters including at least one of skill level and wager amount and (iv) communicate with said remote game devices.

2. The computer-implemented peer-to-peer system of claim 1 wherein said remote wagering management server is further configured to place wagers between players into an escrow.

3. The computer-implemented peer-to-peer system of claim 2 wherein said remote wagering management server is further configured to transfer wagers in escrow to a winning player.

4. The computer-implemented peer-to-peer system of claim 1 wherein said wagering software is configured to monitor against tampering of said wagering software while a game is being played.

5. The computer-implemented peer-to-peer system of claim 1 further comprising at least biometric monitoring software on said remote game devices.

6. The computer-implemented peer-to-peer system of claim 5 wherein said biometric monitoring software captures biometric data systematically or randomly.

7. A computer-implemented peer-to-peer skill-based gaming system comprising:
one or more game host servers accessible via remote game devices;
a skill-based game application and wagering software on said remote game devices;
one or more databases;
geo-location software configured to define a geo-fenced area; and
a remote wagering management server configured to: (i) validate and authenticate players and locations thereof; (ii) accept and manage wagers between players located in said geo-fenced area and (iii) communicate with said remote game devices.

8. The computer-implemented peer-to-peer system of claim 7 wherein said geo-fenced area is a casino, stadium, bar, ship, aircraft, building, city or state.

9. The computer-implemented peer-to-peer system of claim 7 wherein said remote wagering management server is further configured to place wagers between players into an escrow.

10. The computer-implemented peer-to-peer system of claim 9 wherein said remote wagering management server is further configured to transfer wagers in escrow to a winning player.

11. The computer-implemented peer-to-peer system of claim 7 wherein said wagering software is configured to monitor against tampering of said wagering software while a game is being played.

13. The computer-implemented peer-to-peer system of claim 7 further comprising at least biometric monitoring software on said remote game devices.

14. The computer-implemented peer-to-peer system of claim 13 wherein said biometric monitoring software captures biometric data systematically or randomly.

15. The computer-implemented peer-to-peer system of claim 7 wherein said remote wagering management server is further configured to receive specific location details entered by players via said game devices.

16. A computer-implemented peer-to-peer skill-based gaming system comprising:
one or more game host servers accessible via remote game devices;
a skill-based game application and wagering software on said remote game devices;
one or more databases;
a live video capture device configured to capture live game data;
a bet algorithm to utilize said captured live game data to generate in-game propositional wagers; and
a remote wagering management server configured to: (i) validate and authenticate players and locations thereof; (ii) accept propositional wagers on a game, said propositional wagers by persons not playing said game and (iii) resolve said propositional wagers.

17. The computer-implemented peer-to-peer skill-based gaming system of claim 16 wherein said live video capture device is configured to decode video frames for purposes of identifying wager variables to create propositional wagers.

18. The computer-implemented peer-to-peer system of claim 16 further comprising at least biometric monitoring software on said remote game devices.

19. The computer-implemented peer-to-peer system of claim 18 wherein said biometric monitoring software captures biometric data systematically or randomly
